(19) United States
(12) Patent Application Publication
(10) Pub. No.: US 2013/0228099 A1
(43) Pub. Date: Sep. 5, 2013

(54) COMPOSITE MATERIAL

(71) Applicant: TERUMO KABUSHIKI KAISHA, Shibuya-ku (JP)

(72) Inventors: Ryoichi Soba, Kanagawa (JP); Hiraku Murayama, Shizuoka (JP)

(73) Assignee: TERUMO KABUSHIKI KAISHA, Shibuya-ku (JP)

(21) Appl. No.: 13/865,584

(22) Filed: Apr. 18, 2013

Related U.S. Application Data
(63) Continuation of application No. PCT/JP2011/074131, filed on Oct. 20, 2011.

(30) Foreign Application Priority Data
Nov. 1, 2010 (JP) 2010-245023

(51) Int. Cl. C09K 3/00

(52) U.S. Cl. CPC C09K 3/00
USPC 106/286.4

(57) ABSTRACT

To realize an improved plateau region stress level in a composite material that includes a superelastic shape memory alloy as a matrix, the composite material is a composite material including a superelastic shape memory alloy as a matrix, with carbon nanomaterials dispersed in the matrix.

### CROSS REFERENCES TO RELATED APPLICATIONS

This application is a continuation of International Application PCT/JP2011/074131 filed on Oct. 20, 2011, which claims priority to Japanese Patent Application No. 2010-245023 filed on Nov. 1, 2010, the entire content of both of which is hereby incorporated by reference.

### TECHNICAL FIELD

The present invention generally relates to a composite material comprising a superelastic shape memory alloy as a matrix.

### BACKGROUND DISCUSSION

NiTi alloys, FeMnSi alloys, and CuAlNi alloys are generally called shape memory alloys, and there is an alloy (superelastic shape memory alloy) showing superelasticity at least at human body temperature (around 37° C.). The term, “superelasticity” herein means the properties, of which even if the material is deformed (bent, stretched, compressed, and twisted) at service temperature to the region in which ordinary metals undergo plastic deformation, releasing the deformation results in recovery to nearly the original shape before deformation without heating.

These characteristics of such superelastic shape memory alloys have been used in various applications, and for example, NiTi alloys are used as the base material for medical devices such as stents and guide wires (see the claims in Japanese Patent Application Laid-Open No. 2003-325655 and paragraphs [0011] and [0016] in Japanese Patent Application Laid-Open No. Hei 9-182799.

Since such superelastic shape memory alloys are generally a “soft metal”, in some cases, the stress in the plateau region (the region in which the stress remains nearly constant in an increase of strain in the stress-strain curve) is insufficient depending on the application.

### SUMMARY

The present inventors extensively studied this matter and discovered that it is possible to improve the plateau region stress level by utilizing a composite material comprised of superelastic shape memory alloy as a matrix, with carbon nanomaterials dispersed in the matrix.

According to one aspect of the disclosure here, a medical device is made of composite material, wherein the composite material comprises a matrix that includes a superelastic shape memory alloy and carbon nanomaterials.

According to another aspect, a composite material comprises a superelastic shape memory alloy as a matrix, wherein carbon nanomaterials are dispersed in the matrix.

The content of the carbon nanomaterials can be 0.01 parts by mass to 0.5 parts by mass relative to 100 parts by mass of the superelastic shape memory alloy. The superelastic shape memory alloy can be a NiTi alloy, and the matrix can be a sintered body of the superelastic shape memory alloy. The carbon nanomaterials can be carbon nanotubes or carbon black.

The composite material disclosed here exhibits an improved plateau region stress level.

### BRIEF DESCRIPTION OF DRAWINGS

FIG. 1 is a graph illustrating the results of tensile tests in Example 1 and Comparative Example 1.

FIG. 2 is a graph illustrating the results of hysteresis tests in Example 1.

FIG. 3 is a graph illustrating the results of hysteresis tests in Comparative Example 1.

FIG. 4 is a graph illustrating the results of tensile tests in Examples 2 to 7 and Comparative Example 2.

FIG. 5 is a graph illustrating the results of cycle 1 of hysteresis tests in Examples 2 to 7 and Comparative Example 2.

FIG. 6 is a graph illustrating the results of cycle 2 of the hysteresis tests in Examples 2 to 7 and Comparative Example 2.

FIG. 7 is a graph illustrating the results of cycle 3 of the hysteresis tests in Examples 2 to 7 and Comparative Example 2.

### DETAILED DESCRIPTION

A composite material according to the disclosure here is a composite material comprising a superelastic shape memory alloy as a matrix, in which carbon nanomaterials are dispersed. Each component constituting the composite material according to the disclosure here is described in detail below.

### <Matrix>

The matrix is derived from superelastic shape memory alloys, and is, for example, a sintered body of the superelastic shape memory alloys.

Examples of the superelastic shape memory alloy herein include NiTi alloys, CuAlNi alloys, FeMnSi alloys, CuSn alloys, CuZn alloys, InNiTiAl alloys, FePt alloys, and MnCu alloys. Among them, NiTi alloys are preferred since they can recover from large strains and have excellent biocompatibility.

Representative NiTi alloys include NiTi alloys containing 43% by weight to 57% by weight of Ni and the balance of Ti and unavoidable impurities. A small amount of other elements, for example, cobalt, iron, palladium, platinum, boron, aluminum, silicon, vanadium, niobium, or copper may be added to such NiTi alloys. Among NiTi alloys, alloys containing 54.5% by weight to 57% by weight of Ni and the balance of Ti and unavoidable impurities are particularly preferred. Such NiTi alloys may contain, in addition to Ti and Ni, 0.070% by weight or less of C, 0.050% by weight or less of Co, 0.010% by weight or less of Cu, 0.010% by weight or less of Cr, 0.005% by weight or less of H, 0.050% by weight or less of Fe, 0.025% by weight or less of Nb, and 0.050% by weight or less of O.

### <Carbon Nanomaterials>

The carbon nanomaterials are nanosized materials comprising carbon atoms. The composite material according to the disclosure here is superior in stress in a plateau region relative to superelastic shape memory alloys alone due to the carbon nanomaterials dispersed in the matrix. That is, the plateau region for the composite material exists at a higher stress level than the plateau region for superelastic shape memory alloys alone. It is considered that the improvement is due to reinforcing the dispersed second phase and reinforcing the refinement with the carbon nanomaterials (i.e., the carbon nanomaterial are dispersed in the superelastic shape memory alloy, and so the grain of the superelastic shape memory alloys is refined).

The carbon nanomaterials include carbon nanotubes (CNT), carbon black, fullerenes, and carbon nanocoils. Among them, carbon nanotubes and carbon black are preferred because they can be mass-produced with consistent high quality, and carbon nanotubes are more preferred because their aspect ratio is high.

Carbon nanotubes include, for example, single-layered carbon nanotubes (SWCNT) and multi-layered carbon nanotubes (MWCNT).

The shape of carbon nanotubes is not particularly limited, but an average diameter of the carbon nanotubes in the cross-section is preferably 1 nm to 1,000 nm, more preferably 5 nm to 500 nm. Also, an average total length of carbon nanotubes is preferably 0.1 μm to 1,000 μm, more preferably 10 μm to 1,000 μm. An aspect ratio of carbon nanotubes is preferably 10 to 10,000, more preferably 150 to 1,000.

An average particle diameter of carbon black is preferably 40 nm to 120 nm, more preferably 80 nm to 120 nm.

The content of the carbon nanomaterials is not particularly limited, but the fed content of the carbon nanomaterials (the content of the carbon nanomaterials as raw material before sintering) is preferably 0.01 parts by mass to 0.5 parts by mass relative to 100 parts by mass of the superelastic shape memory alloys, more preferably 0.01 parts by mass to 0.3 parts by mass.

When the content of the carbon nanomaterials is in this range, the stress in the plateau region can be significantly improved. That is, the plateau region for the composite material occurs at a higher stress level

### <Production Method>

The method for producing the composite material disclosed here is not particularly limited, and includes, for example, a method involving sintering a mixture of raw materials comprising the superelastic shape memory alloys and the carbon nanomaterials, and a method involving mixing a sintered product of the superelastic shape memory alloys with the carbon nanomaterials.

As the method of sintering a mixture of raw materials comprising the superelastic shape memory alloys and the carbon nanomaterials, for example, a wet process can preferably be used.

In the wet process, the carbon nanomaterials are dispersed in a predetermined liquid binder to yield a dispersed solution, with which the superelastic shape memory alloys are mixed, followed by heating the mixture to dry and remove the binder, thereby yielding powder of the superelastic shape memory alloys, to the surface of which the carbon nanomaterials are attached. The powder is then sintered and extruded to yield a composite material according to the disclosure here.

The sintering conditions are not particularly limited, but the sintering temperature is preferably 700° C. to 1,200° C., more preferably 800° C. to 1,100° C. When the sintering temperature is kept in this range, the plateau region stress level can be significantly improved while the plateau is maintained.

Application of the composite material according to the present invention is not particularly limited, but the composite material can be used, for example, as a preferred base material for medical devices such as stents, guide wires, embolization coils, inferior vena cava filters, and wires for orthodontics.

### EXAMPLES

Set forth next is a description of various examples utilizing the disclosure here, but it is to be understood that the invention here is in no way limited to the examples.

### Example 1

[Mixing of MWCNT with TiNi Alloys]

MWCNT was added to a binder containing water as a main component to disperse, to which NiTi alloy powder was then added such that the ratio by mass of NiTi alloy powder to MWCNT was 100:0.08. The mixture was then heated at 600° C. to dry and remove the binder, yielding NiTi allow powder, to the surface of which MWCNT was attached.

### [Sintering]

The NiTi alloy powder, to the surface of which MWCNT was attached, was sintered according to the following conditions to yield a sintered body.
Temperature: 900° C.
Retention time: 30 minutes
Atmosphere: Vacuum
Pressure: 40 MPa
Rate of temperature elevation: 20° C./min

### [Hot Extrusion Processing]

The sintered body obtained was subjected to hot extrusion processing according to the following conditions to yield an extruded product.
Preheating temperature: 1,050° C.
Pre-overheating time: 10 minutes
Extrusion ratio: 6
Ram speed: 6 mm/sec

### Example 2

MWCNT was mixed with TiNi alloy powder under the same conditions as Example 1 except for addition of the NiTi alloy powder such that the ratio by mass of NiTi alloy powder to MWCNT was 100:0.07. The other process conditions were the same as those in Example 1.

### Example 3

MWCNT was mixed with TiNi alloy powder under the same conditions as Example 1 except for addition of the NiTi alloy powder such that the ratio by mass of NiTi alloy powder to MWCNT was 100:0.09. The other process conditions were the same as those in Example 1.

### Example 4

[Mixing of MWCNT with TiNi Alloys]

MWCNT was added to and mixed with NiTi alloy powder such that the ratio by mass of NiTi alloy powder to MWCNT was 100:0.05.

### [Sintering]

The mixture obtained was sintered according to the following conditions to yield a sintered body.
Temperature: 900° C.
Retention time: 30 minutes
Atmosphere: Vacuum
Pressure: 40 MPa

### [Hot Extrusion Processing]

The sintered body obtained was subjected to hot extrusion processing according to the following conditions to yield an extruded product.
Preheating temperature: 1,100° C.
Pre-overheating time: 10 minutes
Extrusion ratio: 6
Ram speed: 6 mm/sec

### Example 5

MWCNT was mixed with TiNi alloy powder under the same conditions as Example 4 except for addition of MWCNT such that the ratio by mass of NiTi alloy powder to MWCNT was 100:0.10. The other process conditions were the same as those in Example 4.

### Example 6

MWCNT was mixed with TiNi alloy powder under the same conditions as Example 4 except for addition of MWCNT such that the ratio by mass of NiTi alloy powder to MWCNT was 100:0.15. The other process conditions were the same as those in Example 4.

### Example 7

MWCNT was mixed with TiNi alloy powder under the same conditions as Example 4 except for addition of MWCNT such that the ratio by mass of NiTi alloy powder to MWCNT was 100:0.25. The other process conditions were the same as those in Example 4.

### Comparative Example 1

Without mixing with carbon nanomaterials, NiTi alloy powder alone was sintered under the same conditions as Example 1. The other process conditions were the same as those in Example 1.

### Comparative Example 2

Without mixing with carbon nanomaterials, NiTi alloy powder alone was sintered under the same conditions as Example 4. The other process conditions were the same as those in Example 4.

### <Evaluation>

### [Tensile Test]

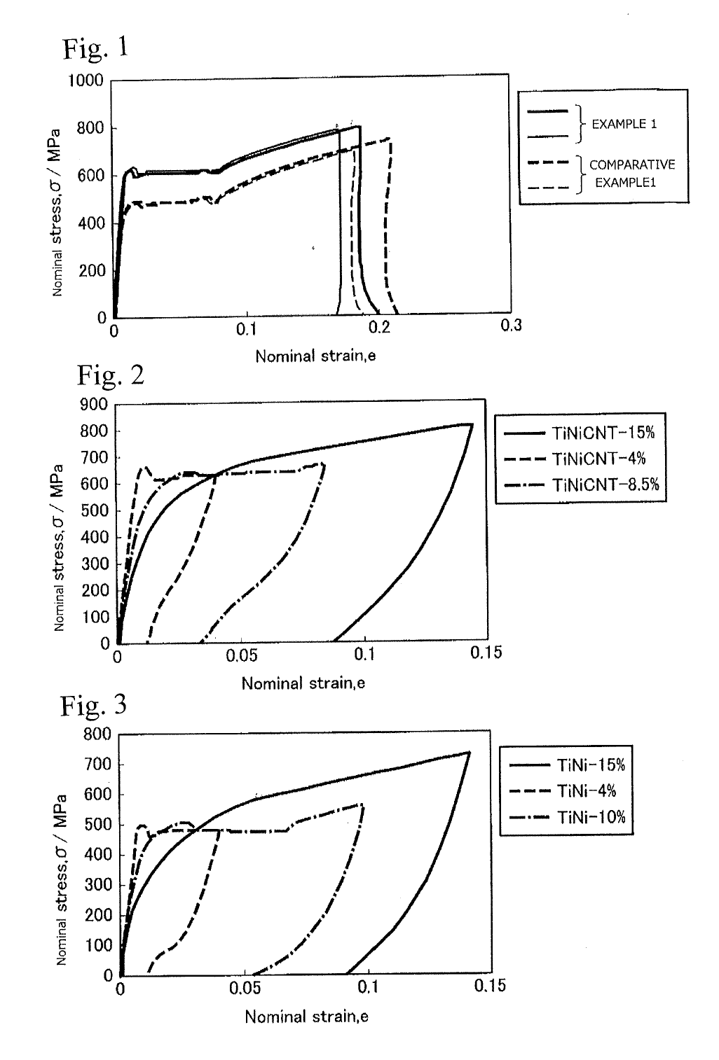

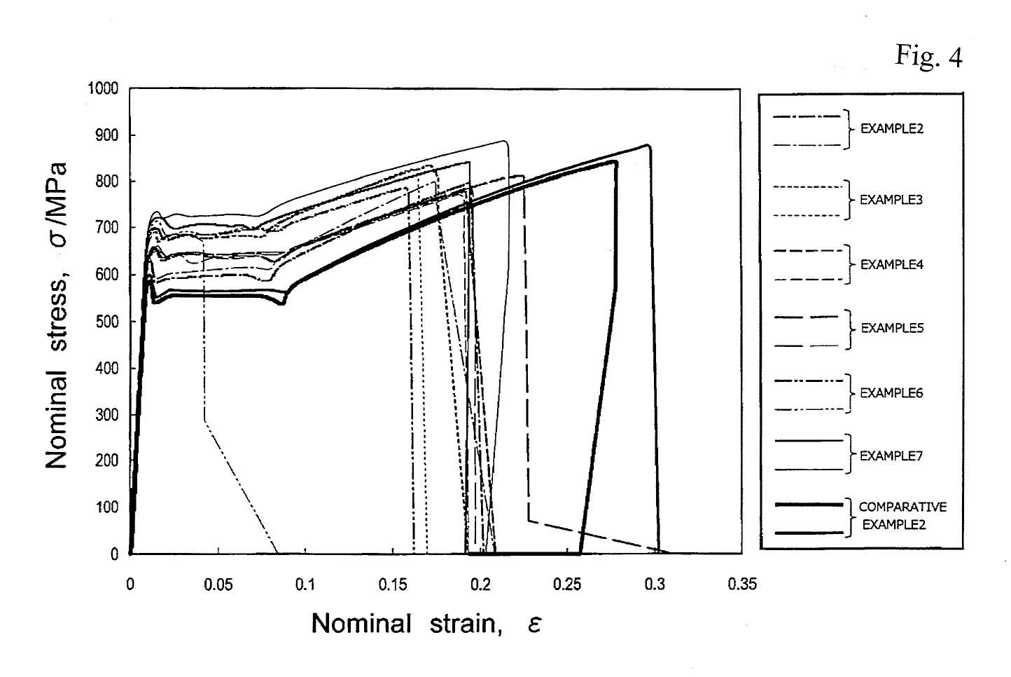

Tensile tests of the extruded products obtained in Examples 1 to 7 and Comparative Examples 1 and 2 were performed at ambient temperature under the following conditions (n=2). FIGS. 1 and 4 illustrate the results in Example 1 and Comparative Example 1, and the results in Examples 2 to 7 and Comparative Example 2, respectively.
Shape of test piece: Round bar
Diameter of test piece: 3.5 mm
Length of test piece: 20 mm
Test speed: Strain rate 5×10⁻⁴ s⁻¹

It was found from the graphs illustrated in FIGS. 1 and 4 that the composite materials in Examples 1 to 7, in which carbon nanotubes were dispersed in the matrix derived from NiTi alloys, were improved in the plateau region stress level as compared to a sintered body of NiTi alloys alone in Comparative Examples 1 and 2. That is, the stress at the plateau region of the stress-strain curve is higher (greater) as compared to Comparative Examples 1 and 2.

### [Hysteresis Test]

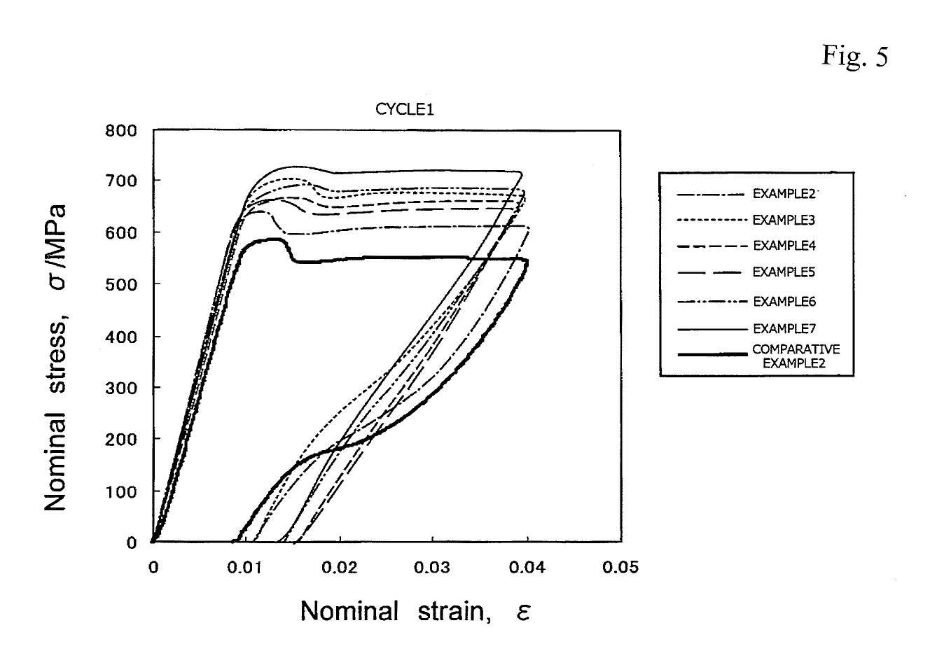

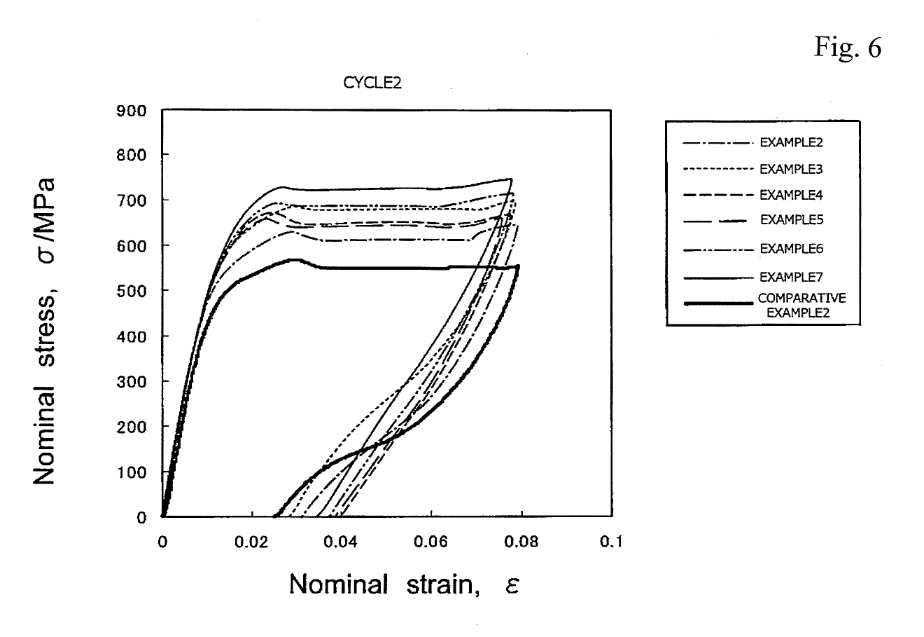

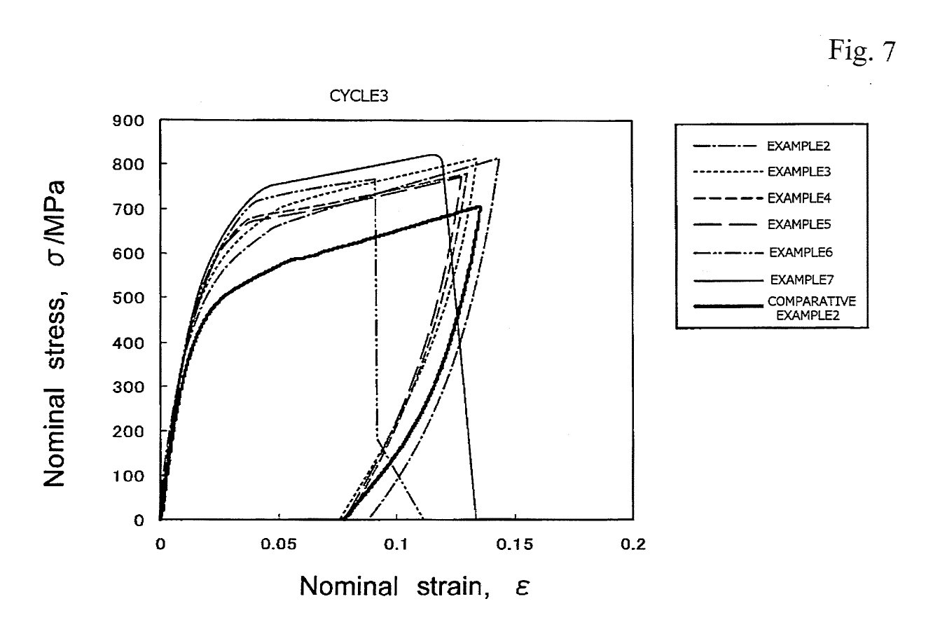

Hysteresis tests involving applying, as a cycle, a constant strain followed by releasing the stress to the extruded products obtained in Examples 1 to 7 and Comparative Examples 1 and 2 were performed according to the following conditions (n=1). The test includes three cycles, in which the strain applied to the test pieces was at 4% at the beginning (cycle 1), then at 8.5% (10% in Comparative Example 1 and 8% in Examples 2 to 7 and Comparative Example 2) (cycle 2), and finally at 15% (14% in Examples 2 to 7 and Comparative Example 2) (cycle 3). FIGS. 2 and 3 illustrate the results in Example 1 and the results in Comparative Example 1, respectively. FIGS. 5, 6, and 7 illustrate the results of cycles 1, 2, and 3 in Examples 2 to 7 and Comparative Example 2, respectively.
Shape of test piece: Round bar
Diameter of test piece: 3.5 mm
Length of test piece: 20 mm
Test speed: Strain rate 5×10⁻⁴ s⁻¹

It was found from the graphs illustrated in FIGS. 2 and 3 as well as FIGS. 5 to 7 that of the composite materials in Examples 1 to 7, in which carbon nanotubes were dispersed in the matrix derived from NiTi alloys, after releasing the stress, the deforming strain was recovered to some degree to the level similar to the sintered body of NiTi alloys alone in Comparative Examples 1 and 2. That is, in the composite materials in Examples 1 to 7, after releasing the stress, the strain (deformation) returned to a level similar to that experienced by the NiTi alloys alone in Comparative Examples 1 and 2. Thus, the composite materials in Examples 1 to 7 are able to be subjected to a higher degree of stress and yet return to a level of strain similar to that experienced by the NiTi alloys alone in Comparative Examples 1 and 2. In Examples 6 and 7, test pieces were broken during cycle 3.

The detailed description above describes features and aspects of a composite material disclosed here. The invention is not limited, however, to the precise embodiments and variations described and illustrated. Various changes, modifications and equivalents could be effected by one skilled in the art without departing from the spirit and scope of the invention as defined in the appended claims. It is expressly intended that all such changes, modifications and equivalents which fall within the scope of the claims are embraced by the claims.

What is claimed is:

1. A medical device made of composite material, the composite material comprising a matrix that includes a superelastic shape memory alloy and carbon nanomaterials.

2. The medical device according to claim 1, wherein the carbon nanomaterials is present in the matrix in an amount of 0.01 parts by mass to 0.5 parts by mass relative to 100 parts by mass of the superelastic shape memory alloy.

3. The medical device according to claim 1, wherein the superelastic shape memory alloy is a NiTi alloy.

4. The medical device according to claim 1, wherein the matrix is a sintered body of the superelastic shape memory alloy.

5. The medical device according to claim 1, wherein the carbon nanomaterials are either carbon nanotubes or carbon black.

6. The medical device according to claim 1, wherein the carbon nanomaterials are either single-layered carbon nanotubes or are multi-layered carbon nanotubes.

7. The medical device according to claim 1, wherein the medical device is one of a stent, a guide wire, an embolization coil, an inferior vena cava filter or an orthodontic wire.

8. A composite material comprising a superelastic shape memory alloy as a matrix, with carbon nanomaterials dispersed in the matrix.

9. The composite material according to claim 8, wherein the carbon nanomaterials is present in the matrix in an amount of 0.01 parts by mass to 0.5 parts by mass relative to 100 parts by mass of the superelastic shape memory alloy.

10. The composite material according to claim 8, wherein the matrix is a sintered body of the superelastic shape memory alloy.

11. The composite material according to claim 8, wherein the carbon nanomaterials are carbon nanotubes or carbon black.

12. The composite material according to claim 8, wherein the superelastic shape memory alloy is a NiTi alloy.

13. The composite material according to claim 9, wherein the matrix is a sintered body of the superelastic shape memory alloy.

14. The composite material according to claim 9, wherein the carbon nanomaterials are carbon nanotubes or carbon black.

15. The composite material according to claim 9, wherein the superelastic shape memory alloy is a NiTi alloy.

16. The composite material according to claim 10, wherein the carbon nanomaterials are carbon nanotubes or carbon black.

17. The composite material according to claim 10, wherein the superelastic shape memory alloy is a NiTi alloy.

18. The composite material according to claim 11, wherein the superelastic shape memory alloy is a NiTi alloy.

19. The composite material according to claim 8, wherein the carbon nanomaterials are either single-layered carbon nanotubes or are multi-layered nanotubes.
